(19) United States
(12) Patent Application Publication
(10) Pub. No.: US 2015/0093175 A1
(43) Pub. Date: Apr. 2, 2015

(54) Writing Instrument with Safety Cap

(71) Applicant: Dallas Lighthouse for the Blind, Dallas, TX (US)

(72) Inventors: Nancy Perkins, Dallas, TX (US); Gordon Spark, Southlake, TX (US); David White, Landenberg, PA (US); Jonathan Kirkpatrick, Downingtown, PA (US); Iam White, Philadelphia, PA (US); Ian McDermott, Lincoln University, PA (US)

(73) Assignee: Dallas Lighthouse for the Blind, Dallas, TX (US)

(21) Appl. No.: 14/263,395

(22) Filed: Apr. 28, 2014

Related U.S. Application Data
(60) Provisional application No. 61/885,598, filed on Oct. 2, 2013.

(51) Int. Cl. B43K 23/12

(52) U.S. Cl. CPC B43K 23/124
USPC 401/202; 401/213

(57) ABSTRACT

A writing instrument with a safety cap is disclosed which comprises a tubular body with a grip body having one end securing a writing tip or nib, and disposed within the tubular body, an ink cartridge for supplying ink to the writing tip or nib. The tubular body comprises a barrel detachably secured to a grip body with a writing tip or nib holder. The barrel may include a retention feature to which the user may safely detachably secure the safety cap while using the instrument. The barrel may include one or more tabs protruding from the barrel body which act to prevent the writing instrument from uncontrolled rolling when the instrument is set down on a surface. A safety cap with one or more vents formed inside the periphery of the cap provide for the bi-directional flow of air or other fluids axially through the cap in the event a user ingests the cap. The nib cover formed in the cap prevents air flow through the vent from contacting the nib or marker tip stored and protected by the safety cap thereby preventing the marker nib or tip from prematurely drying out or from being damaged by exposure to the environment.

### CROSS-REFERENCE TO RELATED APPLICATIONS

This application claims the benefit of and priority to U.S. provisional patent application, Ser. No. 61/885,598, filed on Oct. 2, 2013, the disclosure of which is incorporated herein by reference.

### BACKGROUND OF THE INVENTION

1. Technical Field

The present invention relates to a writing instrument casing and cap, and more particularly to a marker casing and twist safety cap assembly.

2. Description of Related Art

There are many writing instruments, such as ballpoint pens and erasable markers, which have bodies and separable caps. In typical fashion, the cap is removed by the user for utilization of the writing instrument and replaced when such use is finished. However, most prior pen and cap assemblies typically do not provide the requisite fit and/or seal required to keep the cap securely retained to the writing instrument thereby resulting in the writing tip (e.g. felt tip marker, ball point, marker tip, nib) drying out and ceasing to function. In similar manner, the cap is easily dislodged and separated from the writing instrument body that normally results in the user discarding the writing instrument that generates additional waste. Another concern arises when a user, adult or child, places the cap in their mouth and accidentally ingests the cap that may lodge in the user's throat or airway, which clearly presents a choking hazard.

Therefore, a need exists for a writing instrument which includes an effective, detachably securable instrument cap assembly which provides a simple, secure mechanism by which the cap may be easily removed and reattached to the writing instrument body, which is not easily dislodged when being carried or placed in a state of nonuse, and which if ingested by the user includes a safety mechanism allowing the passage of air through the cap by which the user may still effectively breathe until the cap is safely removed from the user's airway and/or esophagus. A need exists in the art for a safety cap which has a secondary vent passageway through which the user may continue to breathe should the safety cap's primary vent passageway become blocked or congested thereby substantially prohibiting the bi-directional flow of air or other fluid through the cap vent passageway.

### SUMMARY OF THE INVENTION

The inventive embodiments disclosed herein include a writing instrument with a safety cap. This summary is not intended to identify key features of the claimed subject matter, nor is it intended to be used as an aid in determining the scope of the claimed subject matter.

A writing instrument with a twist cam-locking cap is disclosed. In one embodiment, a writing instrument comprises a tubular body with a grip body having one end securing a writing tip or nib, and disposed within the tubular body an ink cartridge for supplying ink to the writing tip or nib. In one embodiment, the tubular body comprises a barrel detachably secured to a grip body with a writing tip or nib holder. The barrel is detachably secured to the grip body by an adhesive or other permanent connection means as known in the art. On one end, the barrel may include a retention feature to which the user may safely detachably secure the cap while using the instrument. The writing barrel may also include one or more tabs protruding from the barrel body which act to prevent the writing instrument from uncontrolled rolling along a table, writing board instrument holder or other surfaces when the instrument is set down by the user.

In another embodiment, the cap of the writing instrument disclosed herein comprises one or more openings formed in the cap body running distally from a first end of the cap body to a second end of the cap body providing one or multiple airways by which air will flow bi-directionally if the cap becomes lodged in the mouth, esophagus or airway of a user therefore allowing the user to breathe until the cap is removed. The airway openings are formed in the peripheral circumference of the cap and do not allow air to contact the nib or writing instrument tip protected within the cap, so acting to prevent premature drying of the nib or writing tip.

In another embodiment of the invention disclosed herein, the cap is detachably secured to the writing instrument body with a twist cam-lock mechanism. The cap is guided into the proper mated position with the instrument body grip or grip body by opposing protrusions in the cap interior that slide in a twisting motion along arcuate receiving grooves formed in the nib holder secured to the instrument body. As the user pushes and twists the cap and nib holder into the closed position, the cap releasably locks into the closed mated position with the grip body whereby the tabs formed in the cap assembly become friction locked with tab receiving grooves formed in the grip body and nib holder sufficient to retain the cap and instrument body in a connected position while the writing instrument is being stored or is in a period of nonuse.

### BRIEF DESCRIPTION OF THE FIGURES

The foregoing aspects and many of the features and advantages of the invention will become readily appreciated, as they become better understood by reference to the following detailed description, when taken in conjunction with the accompanying drawings, wherein:

FIG. 1 is a perspective view of the safety cap and writing instrument with the cap detachably secured to the writing instrument of the disclosed invention;

FIGS. 2A-2D are perspective, plan and cutaway depictions of the safety cap of the disclosed invention;

FIG. 3 is a perspective view of the barrel of the writing instrument body of the disclosed invention;

FIGS. 4A-4B depict front and rear views of the nib holder of the disclosed invention; and,

FIG. 5 depicts a perspective view of the writing instrument body.

### DETAILED DESCRIPTION

Various embodiments are described below with reference to the accompanying figures, which form a part hereof and show, by way of illustration, specific exemplary embodiments. These embodiments are disclosed in sufficient detail to enable those of ordinary skill in the art to practice the invention. However, embodiments may be implemented in many different forms and should not be construed as being limited to the embodiments set forth herein. The following detailed description is therefore not to be taken in a limiting sense.

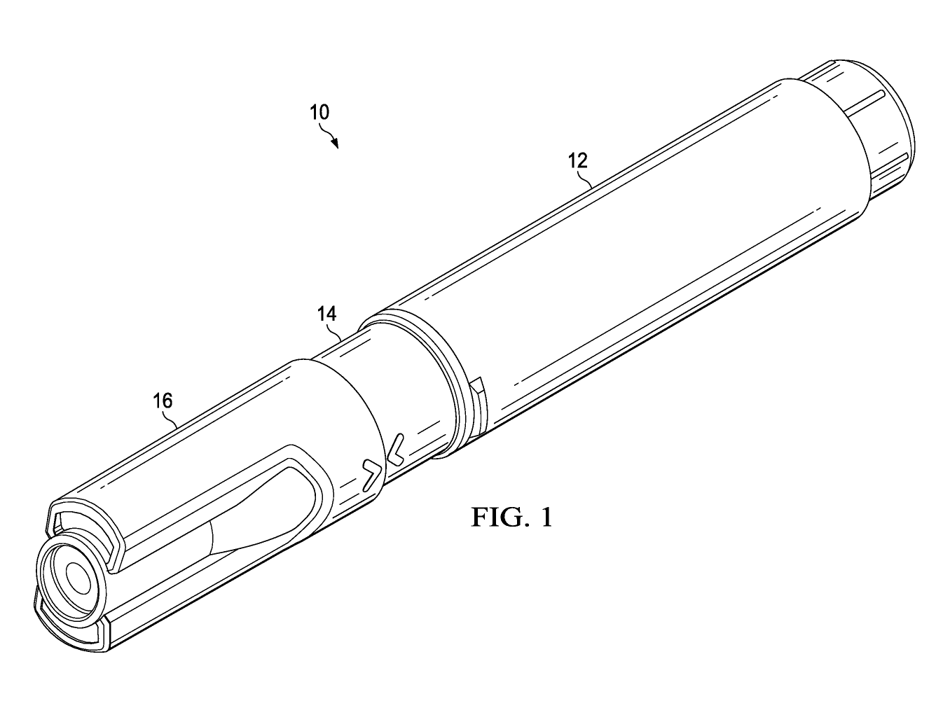

An embodiment of the writing instrument 10 is shown in FIG. 1. Writing instrument 10 includes a barrel 12, a grip body 14, and a cap 16. Cap 16 serves to cover and protect a writing tip or nib (not shown) and which is in communication with an ink cartridge or ink well (not shown) enclosed within barrel 12. Writing tip or nib may be provided in various forms, such as a felt tip, rollerball, ball point, or other known writing tips and nibs. A writing ink or medium will be stored within barrel 12 and in communication with the writing tip or nib so as to provide an ink or writing medium source and supply to the writing tip or nib. Grip body 14 serves to retain the writing tip (hereinafter “nib”) and to provide a grip area sufficient for a user to comfortably grip the writing instrument 10 and position the nib in the location desired for writing or drawing by the user. Grip body 14 is secured to barrel 12 by coupling means such as adhesives, mating threads, mating snaps, mating tabs, mating cam twist-locks or other known connection structures as is known in the art.

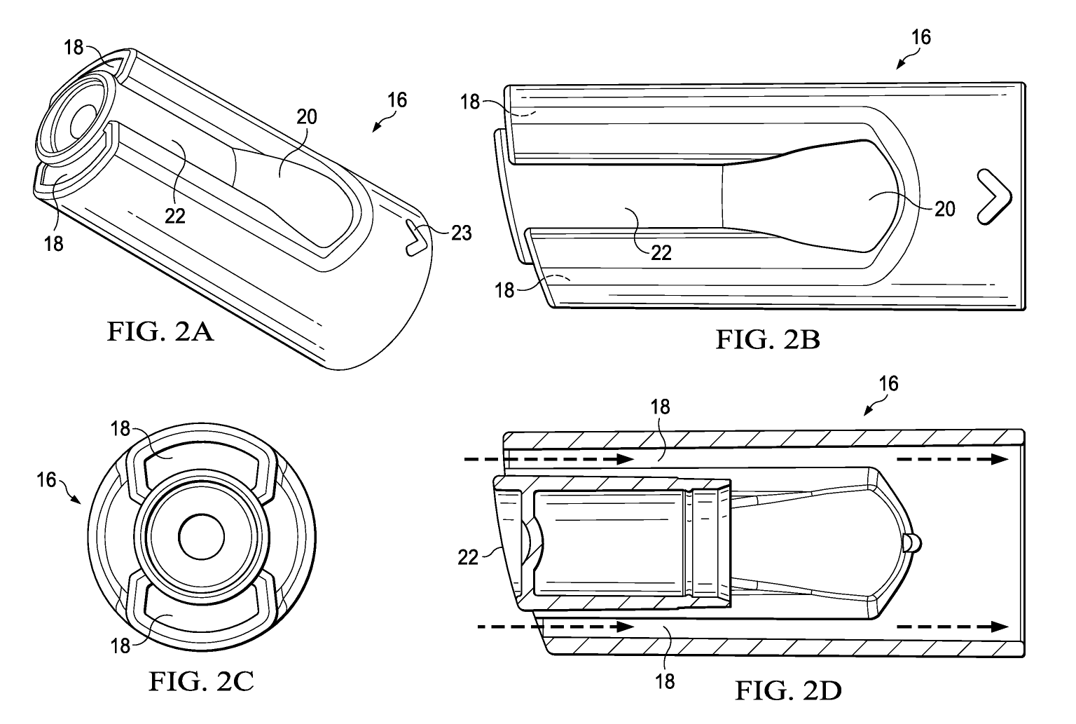

Turning to FIGS. 2A-2D, various views of cap 16 are shown in detail. Cap 16 includes one or more vents 18, a grip cover 20, a nib cover 22, and a cap alignment indicator 23 formed as shown. As shown in FIGS. 2A, 2B and 2C, one or more vents 18 are formed in the interior periphery of cap 16 and provide an unobstructed axial passage way from a first end of cap 16 to a second end of cap 16. Referring to FIGS. 2B and 2D, grip cover 20 is a conically shaped structure within the cap 16 and is dimensioned to receive and cover the corresponding portion of grip body 14 as further described herein. Nib cover 22 is a cylindrically shaped structure formed within cap 16 and is dimensioned to receive and cover the corresponding nib (not shown) as further described herein. As shown in the sectional view presented in FIG. 2D, vent or multiple vents 18 provide a pathway for air or other fluids to freely move bi-directionally in and through the vent 18 passageway, yet vents 18 do not allow air or other fluids to contact or otherwise flow into the grip cover 20 and/or the nib cover 22. As such, the cap 16 still functions to keep the nib from drying out during periods of non-use, yet still provides the ability for air other fluids to flow bi-directionally should a person accidentally swallow cap 16 into their airway thereby allowing the person to continue breathing until cap 16 can be safely removed from the person's airway. Embodiments which include at least two vents 18 provide an extended capability for air or other fluids to move through at least one vent 18 should a second vent 18 become inoperable due to the orientation of the cap in a person's airway or blockage by debris becoming lodged in a vent 18 after accidental ingestion. Referring to FIG. 2B, cap alignment indicator 23 is shown formed into cap 16 as a raised arrow point providing the user with a visible and tactile reference point for users by which to orient the cap 16 in an appropriate manner to receive and releasably mate with corresponding grip body 14 during periods of nonuse.

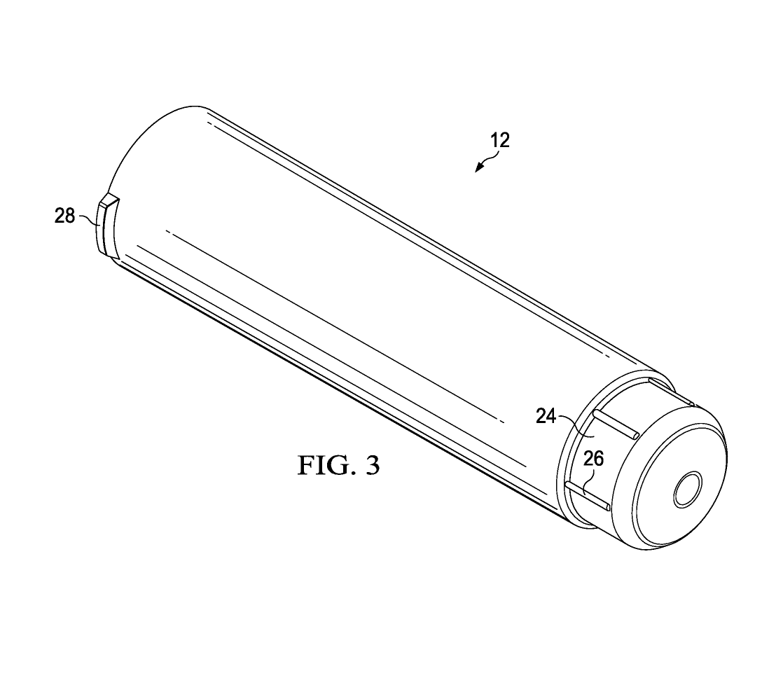

FIG. 3 shows barrel 12 in a perspective view. Barrel end 24 is a formed end of barrel 12 with raised ribs 26 formed around the circumference of barrel end 24. Ribs 26 act as securably releasable friction locks which releasably mate with cap 16 so as to provide a cap retention mechanism while the writing instrument 10 is being utilized for writing or drawing by the user. One or more barrel tabs 28 are formed as a raised tab portion on barrel 12 and provide an “anti-roll” capability to prevent the writing instrument 10 from rolling along, and possibly off, a surface upon which the user has laid the writing instrument 10. Barrel tab 28 also serves to assist the user in aligning the cap 16 and grip body 14 into appropriate position to receive and releasably mate together when the writing instrument 10 is not in use.

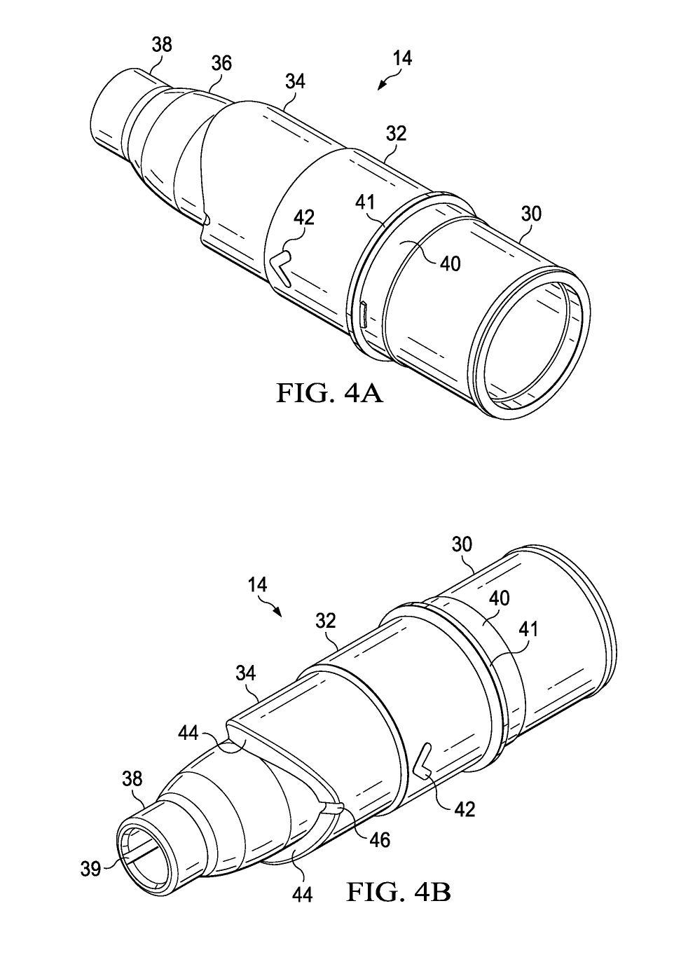

FIG. 4A is a rear perspective view of an embodiment of the grip body 14 of the writing instrument 10 shown in greater detail. Grip body 14 includes a lower grip end 30, a lower grip 32, a mid grip 34, an upper grip 36, and a nib holder 38. A grip end flare 40 comprises one or more raised, circumferential rings formed on the surface of grip body 14 as shown and which act has friction locks when mated with corresponding barrel end flare rings formed in the interior of barrel 12 (not shown) which act to secure the grip body 14 to the barrel 12. Grip ring 41 is a formed, circumferential raised ring that acts as a stop and seal when barrel 12 and grip body 14 are mated together. The lower grip end 30 is inserted into the open end of barrel 12 and the two are pushed together until the grip ring 30 is in contact with the barrel 12. Once mated together, barrel 12 and grip body 14 are secured together and sufficiently sealed to prevent leakage of ink or other writing medium stored or contained within the barrel 12. Grip alignment indicator 42 is shown formed as a raised arrow point on the surface of lower grip 32 providing the user with a visible and tactile reference point to align the cap alignment indicator 23 with the grip alignment indicator 42 and thereby orient the cap 16 in an appropriate manner to receive and releasably mate with corresponding grip body 14 during periods of nonuse or storage.

FIG. 4B is a front perspective view of an embodiment of the grip body 14 shown in greater detail. Proceeding forward of the grip ring 41, lower grip 32, mid grip 34, upper grip 36 and nib holder 38 are shown. It should be noted in the depicted embodiment that the grip body 14 comprises a monolithic assembly which may be formed and manufactured by known plastic and metal fabrication methods such as injection molding, blow molding and cast manufacturing as known in the plastic and metal arts. Lower grip 32, mid grip 34, upper grip 36 and nib holder 38 are generally formed as a series of cylindrical or conical shapes with decreasing diameters from the lower grip 32 to the nib holder 38. Lower grip 32 provides sufficient surface area for the user to hold the writing instrument 10 comfortably during use. Lower grip 32 also includes raised, formed grip alignment indicator 42. As previously described, the user utilizes cap alignment indicator 23 to align the cap 16 with the grip alignment indicator 42 so as to provide a visual and tactile tool with which the user may appropriately align grip body 14 with cap 16 when placing the cap 16 on the writing instrument 10 for storage or during periods of nonuse.

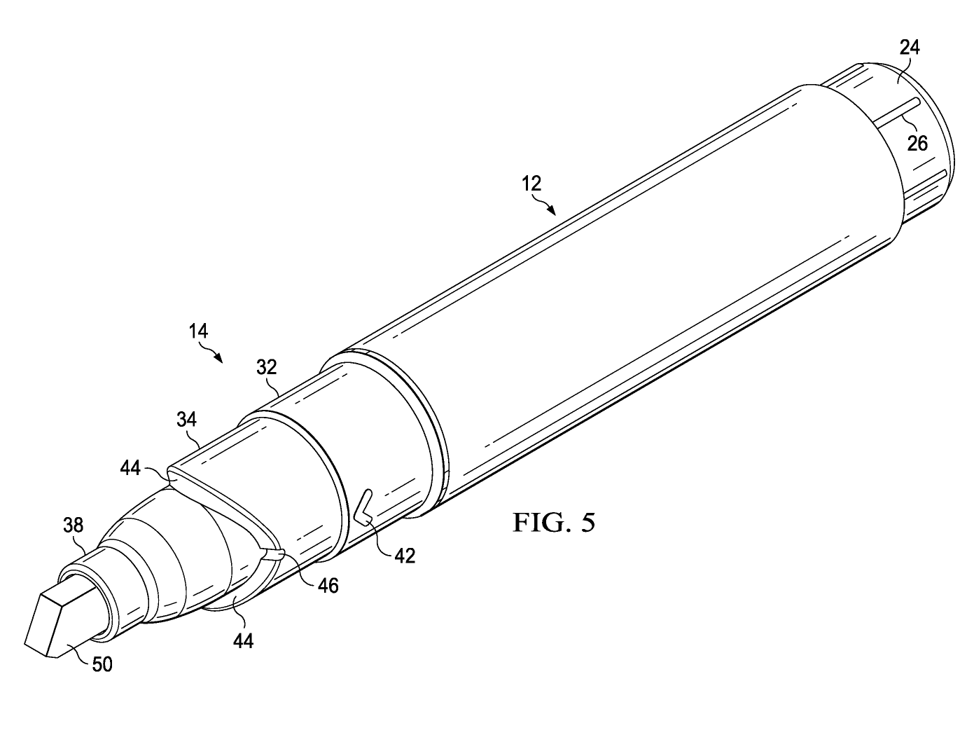

Nib holder 38 is dimensioned to accept commonly known standard nibs. One or more nib retention slots 39 are formed within the interior surface of nib holder 38 and provide a guide pathway for the edges of the nib 50 (shown in FIG. 5) inserted into the nib holder 38. Nib retention slots 39 also act to prevent rotation and movement of the nib 50 within the nib holder 38 during use of the writing instrument 10. The nib retention slots 39 also act to prevent axial movement of the nib 50 in the nib holder 38 during use of the writing instrument 10.

Turning to FIG. 5, a perspective view of the writing instrument is shown with nib 50 inserted into nib holder 38. Proceeding forward of the lower grip 32, mid grip 34 is shown which includes an arcuate surface edge 44 that is formed as part of the mid grip 34. Mid grip slots 46 are formed about 180 degrees opposite of each other for receiving corresponding cap locking detents (not shown) which are formed in the corresponding locations within the peripheral interior of cap 16 such that when cap 16 is properly aligned with grip body 14 utilizing cap alignment indicator 23 and grip alignment indicator 42, the locking detents in the cap 16 are releasably secured by mid grip slots 46 providing sufficient retention force to keep cap 16 secured to grip body 14 during storage and non-use.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. While various alterations and permutations of the invention are possible, the invention is to be limited only by the following claims and equivalents.

Various embodiments of the invention described herein may also include as follows: In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22; and, a cap alignment indicator 23 located on a surface of the cap 16. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22; and, a grip alignment indicator 42 located on a surface of the grip body 14. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22; and, a barrel tab 28 formed on the exterior surface of the barrel 12. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22; and, wherein the grip body 14 includes a lower grip end 30, a lower grip 32, a mid grip 34, and an upper grip 36. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22; and, a second vent 18 extending along the interior length of the cap 16. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22; and, at least one rib 26 formed on the outer periphery of the barrel 12 and opposite the grip body 14. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22; and, a nib retainer slot 39 formed along the interior surface of the nib holder 38. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22, wherein the grip body 14 includes a lower grip end 30, a lower grip 32, a mid grip 34, and an upper grip 36; and, a grip ring 41 formed on the exterior surface of the grip body 14 between the lower grip end 30 and the lower grip 32. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22, wherein the grip body 14 includes a lower grip end 30, a lower grip 32, a mid grip 34, and an upper grip 36; and, a mid grip slot 46. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22, wherein the grip body 14 includes a lower grip end 30, a lower grip 32, a mid grip 34, and an upper grip 36; and, a grip ring 41 formed on the exterior surface of the grip body 14 between the lower grip end 30 and the lower grip 32; and, a grip end flare 40 positioned adjacent to the grip ring 41. In an embodiment, there is disclosed a writing instrument comprising a barrel 12; a grip body 14, with a nib holder 38 wherein the grip body 14 is inserted into and secured to the barrel 12; and, a cap 16 releasably securable to the grip body 14 wherein the cap 16 includes a nib cover 22 and at least one vent 18 extending along the interior length of the cap 16, wherein air or other fluids may pass bi-directionally through the at least one vent 18 without contacting a nib 50 secured by the nib holder 38 and enclosed by the nib cover 22; and, a cap locking detent formed in the peripheral interior of the cap 16.

We claim:

1. A writing instrument, comprising:
a barrel;
a grip body with a nib holder wherein the grip body is inserted into and secured to the barrel; and,
a cap releasably securable to the grip body wherein the cap includes a nib cover and at least one vent extending along the interior length of the cap, wherein air or other fluids may pass bi-directionally through the at least one vent without contacting a nib secured by the nib holder and enclosed by the nib cover.

2. The writing instrument of claim 1 further comprising:
a cap alignment indicator located on a surface of the cap.

3. The writing instrument of claim 1 further comprising:
a grip alignment indicator located on a surface of the grip body.

4. The writing instrument of claim 1 further comprising:
a barrel tab formed on the exterior surface of the barrel.

5. The writing instrument of claim 1 wherein the grip body includes a lower grip end, a lower grip, a mid grip and an upper grip.

6. The writing instrument of claim 1 further comprising:
a second vent extending along the interior length of the cap.

7. The writing instrument of claim 1 further comprising:
at least one rib formed on the outer periphery of the barrel end opposite the grip body.

8. The writing instrument of claim 1 further comprising:
a nib retainer slot formed along the interior surface of the nib holder.

9. The writing instrument of claim 5 further comprising:
a grip ring formed on the exterior surface of the grip body between the lower grip end and the lower grip.

10. The writing instrument of claim 5 further comprising:
a mid grip slot.

11. The writing instrument of claim 9 further comprising:
a grip end flare positioned adjacent to the grip ring.

12. A writing instrument cap, comprising:
a vent formed in the interior periphery and extending the axial length of the cap;
a grip cover formed inside the periphery of the cap and adapted to receive and cover a portion of a grip body;
a cylindrical nib cover formed inside the periphery of the cap and adapted to receive and cover a nib; and,
a cap alignment indicator on the surface of the cap.

13. The writing instrument cap of claim 12 further comprising:
a second vent formed in the interior periphery and extending the axial length of the cap.

14. The writing instrument cap of claim 12 further comprising:
a cap alignment indicator formed on an exterior surface of the cap.

15. The writing instrument cap of claim 12 further comprising:
a cap locking detent formed in the peripheral interior of the cap.
